(19) United States
(12) Patent Application Publication
(10) Pub. No.: US 2017/0160782 A1
(43) Pub. Date: Jun. 8, 2017

(54) SHARE POWER SOURCE MECHANISM IN A MULTICORE PROCESSOR SYSTEM

(71) Applicant: MediaTek Inc., Hsinchu (TW)

(72) Inventors: Ya-Ting Chang, Hsinchu (TW); Jia-Ming Chen, Zhubei (TW); Nicholas Ching Hui Tang, Zhudong Township (TW); Pi-Cheng Hsiao, Taichung (TW)

(21) Appl. No.: 15/236,247

(22) Filed: Aug. 12, 2016

Related U.S. Application Data
(60) Provisional application No. 62/263,762, filed on Dec. 7, 2015.

(51) Int. Cl. G06F 1/32

(52) U.S. Cl. CPC G06F 1/3203; G06F 1/325; G06F 1/329

(57) ABSTRACT

A multicore processor system utilizes a power manager for improving power consumption. The system includes multiple processing units and multiple power sources. Each power source is connected to two or more processing units. A condition for activating a processing unit is detected. In response to the detected condition, the power manager identifies a power source that is connected to inactive processing units only. The power manager then activates a target processing unit among the inactive processing units connected to the identified power source.

### CROSS-REFERENCE TO RELATED APPLICATIONS

This application claims the benefit of U.S. Provisional Application No. 62/263,762 filed on Dec. 7, 2015.

### TECHNICAL FIELD

Embodiments of the disclosure relate to power management in a multicore processor system.

### BACKGROUND

A multicore processor system typically use a voltage regulator to supply power to its processors or clusters. A voltage regulator is designed to automatically maintain a constant voltage level. Voltage regulators are found in electronic devices such as computer power supplies, where they stabilize the DC voltages used by processors and other electronic components. Many types of voltage regulators are commonly in use, such as linear regulators and switching regulators.

Linear regulators are based on devices that operate in their linear region. A linear regulator maintains a constant output voltage by adapting its resistance to the load. The difference between the input and the regulated output voltages is dissipated as heat. Because the regulated output voltage is lower than the input voltage, efficiency of a linear regulator is limited.

By contrast, a switching regulator uses an active device that switches on and off to maintain an average value of output. Modern computers or computing devices typically use a switching regulator to supply power to its processors and other electronic components. A switching regulator is sometimes referred to as a “buck regulator,” “buck converter” or “buck.”

A multicore processor system can sometimes experience workload imbalance across its processors. Such unbalanced workload causes unbalanced demand on power among the processors. Power efficiency in such a system is of major concern.

### SUMMARY

In one embodiment, there is provided a method for improving the power consumption of a system. The system includes multiple processing units and multiple power sources, wherein each power source is connected to two or more processing units. The method comprises: detecting a condition for activating a processing unit; in response to the detected condition, identifying a power source that is connected to inactive processing units only; and activating a target processing unit among the inactive processing units connected to the identified power source.

In another embodiment, there is provided a system operative to improve power consumption. The system comprises: a plurality of processing units and a plurality of power sources. Each power source is connected to two or more processing units. The system further comprises a power manager module coupled to the processing units. The power manager module is further operative to: detect a condition for activating a processing unit among the plurality of processing units; in response to the detected condition, identify a power source that is connected to inactive processing units only; and activate a target processing unit among the inactive processing units connected to the identified power source.

### BRIEF DESCRIPTION OF THE DRAWINGS

The present disclosure is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 illustrates a block diagram of a multicore processor system according to one embodiment.

FIG. 2A illustrates a diagram of a set of power sources connecting to a set of processing units according to one embodiment.

FIG. 2B illustrates a diagram of a set of power sources connecting to two different sets of processing units according to one embodiment.

FIGS. 3A-3E illustrate a sequence of operations that activate and deactivate processing units according to one embodiment.

FIG. 4 is a diagram illustrating a data structure for tracking activation and deactivation of processing units according to one embodiment.

FIG. 5 is a flow diagram illustrating a method for managing activation and deactivation of processing units according to one embodiment.

FIG. 6 is a flow diagram illustrating a method for selecting a processing unit to activate according to one embodiment.

### DETAILED DESCRIPTION

In the following description, numerous specific details are set forth. However, it is understood that embodiments of the disclosure may be practiced without these specific details. In other instances, well-known circuits, structures and techniques have not been shown in detail in order not to obscure the understanding of this description. It will be appreciated, however, by one skilled in the art, that the disclosure may be practiced without such specific details. Those of ordinary skill in the art, with the included descriptions, will be able to implement appropriate functionality without undue experimentation.

It should be noted that the term “multicore processor system” as used herein is a system that includes multiple processors. In one embodiment, each processor is equivalent to a central processing unit (CPU), which may contain one or more cores. Alternatively, one or more of the processors may be a special-purpose processor or accelerator that contains one or more cores, which are also referred to as processing elements. The multiple processors may be arranged and managed as one or more clusters. Moreover, the term “processing unit” as used herein refers to a cluster of processors, a processor of multiple cores, or a core. The term “power source” as used herein refers to a circuitry that supplies power to one or more processing units and maintains the output voltage level supplied to the processing units. Examples of a power source include a voltage regulator such as a switching regulator (i.e., a “buck”), or a linear regulator such as a low-dropout (LDO) circuit. In one embodiment, a system may include multiple bucks, each supplying a different voltage to one or more processing units. In this embodiment, each buck is called a power source. In an alternative embodiment, each of these multiple bucks supplies its output voltage to multiple LDOs. Each LDO supplies a voltage to one or more processing units. In this alternative embodiment, each LDO is called a power source. A system may include a combination of any number of bucks and any number of LDOs.

Embodiments of the invention improve power consumption of a multicore processor system. The system includes multiple (e.g., N) processing units and multiple (e.g., M) power sources, where M and N are positive integers greater than one. Each of the M power sources may be connected to two or more processing units. In a typical low power usage scenario, the number of required processing units for handling the system workload is often less than or equal to the number of power sources (M). In one embodiment, the number of required processing units may be the same as, or a factor of, the number of parallel tasks in the workload. The number of parallel tasks in a workload is sometimes referred to as Task-Level Parallelism (TLP).

When the number of required processing units for handling the workload is less than or equal to M, for each power source, a power manager of the system activates no more than one processing unit among all processing units connected to that power source. Power efficiency and power consumption can be improved when each activated processing unit receives power from a different power source. By contrast, if multiple activated processing units draw power from the same power source and the workload among these processing units is unbalanced, the system would operate with poor power efficiency and high power consumption.

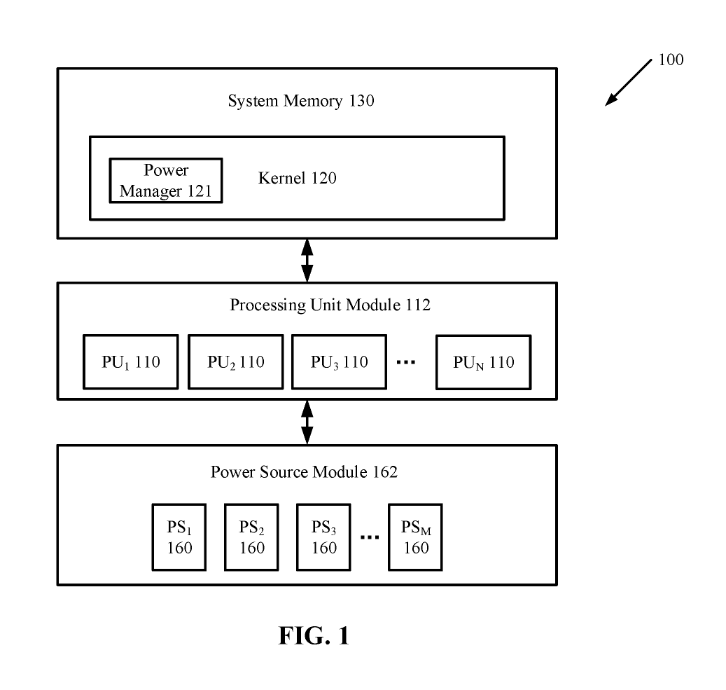

FIG. 1 illustrates an example architecture of a multicore processor system 100 according to one embodiment. The multicore processor system 100 (hereinafter referred to as the system 100) includes a processing unit module 112, which further includes a plurality of processing units 110 (e.g., PU₁, PU₂, PU₃, . . . , PU_{N}). The processing units 110 may have different power efficiency and/or different processing capabilities; that is, the processing units 110 may be of different processor types. The term “processor type” or, equivalently, “type” as used herein refers to the hardware characteristics with respect to processing capacities (e.g., measured by million instructions per second (MIPS)) and/or power efficiency (e.g., measured by power consumption for a range of operating frequencies).

In one embodiment where the processing units 110 are of different types, some of the processing units 110 may have higher power consumption and higher processing capability than others. Those processing units 110 having similar power consumption may have different processing capabilities. In some embodiments, all of the processing units 110 may be of the same type. Each processing unit 110 has access to a system memory 130 (e.g., dynamic random access memory (DRAM) or other volatile or non-volatile random-access memory) via a bus or an interconnection network.

The processing units 110 are connected to a power source module 162 that includes a plurality of power sources 160 (e.g., PS₁, PS₂, PS₃, . . . , PS_{M}). Each power source 160 is connected to two or more processing units 110, and each processing unit 110 is connected to only one power source 160. In one embodiment, each power source 160 is a voltage regulator (e.g., a buck or an LDO) that provides a direct current (DC) voltage to one or more of the processing units 110. The power source 160 converts a common source voltage into one or more DC voltages that are suitable for the operations of the processing units 110.

In one embodiment, the system 100 includes a power manager module, also referred to as a power manager 121, to manage power supplied from the power sources 160 to the processing units 110. In particular, the power manager 121 may determine which processing units 110 to turn on or off in order to optimize power efficiency of the system 100. In one embodiment, the power manager 121 may be part of a kernel 120 executed on the system 100. The kernel 120 is part of an Operating System (OS) that mediates access to system resources, and is responsible for enabling user applications to effectively share the hardware by controlling access to the processors, memory, disk I/O, and network. In an alternative embodiment, the power manager 121 may be implemented by hardware, firmware, or a combination of software and hardware/firmware.

In one embodiment, the system 100 may be part of a mobile computing and/or communication device (e.g., a smartphone, a tablet, laptop, etc.). In one embodiment, the system 100 may be part of server computer.

In one embodiment, the power manager 121 determines which processing units 110 to activate and which processing units 110 to deactivate. A processing unit 110 is “activated” or, equivalently, “active” when it is turned on from a power-off state (i.e., receives no power) or an ultra-low power state (i.e., in deep sleep). Power consumed by a processing unit 110 in an ultra-low power state can be as low as to retain data in the caches but not sufficient to afford logical calculations. An activated processing unit may be actively processing tasks or may enter a standby state ready to process tasks. A processing unit 110 is “deactivated” or, equivalently, “inactive” when it enters the power-off state or the ultra-low power state.

In one embodiment, the power manager 121 also determines the required voltage for each activated processing unit 110. The required voltage is the minimum voltage for the processing unit 110 to process its assigned workload to achieve a required performance. That is, for each processing unit 110, the voltage received from its power source 160 cannot be less than its required voltage. During runtime, the required voltages of the processing units 110 may change to adapt to the fluctuation in the workload requirements of the processing units 110. In one embodiment, the power manager 121 performs dynamic frequency and voltage scaling (DVFS) on the system 100 to dynamically adjust the operating frequency and voltage of each processing unit 110 at runtime, such that its operating voltage can keep up with the changes in the required voltage.

Thus, if multiple processing units 110 having unbalanced workload share the same power source, a processing unit having a large workload would require a high operating voltage, and another processing unit having a small workload would be forced to operate at the same voltage, which is higher than its required voltage. This higher voltage results in unnecessary power consumption and power inefficiency. Therefore, the system and method described herein provide a solution to the power efficiency problem for typical usage scenarios where the number of required processing units 110 is not greater than the number of power sources 160.

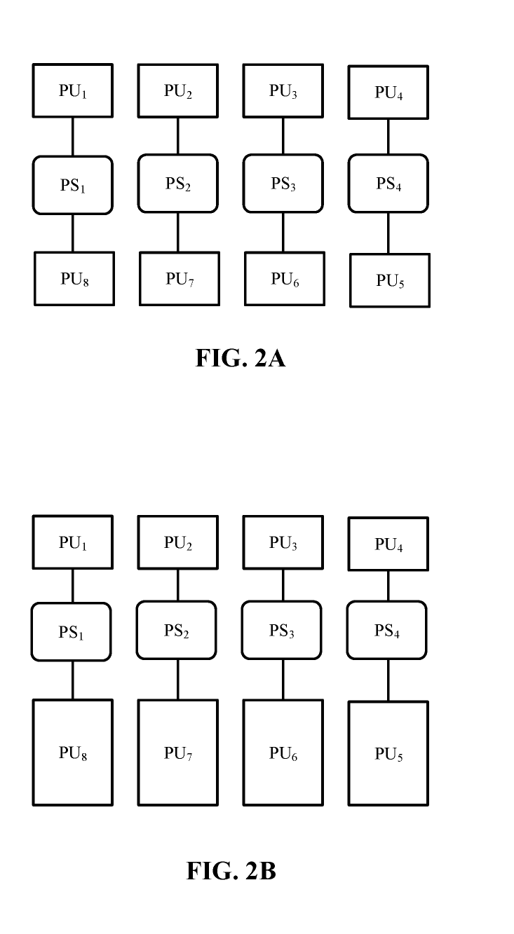

FIG. 2A and FIG. 2B illustrate two examples of the power sources 160 connecting to the processing units 110 in the system 100, according to some embodiments. FIGS. 2A and 2B use the same notation as in FIG. 1, where the power sources 160 are denoted as “PS” and the processing units 110 are denoted as “PU”. In these examples, each processing unit 110 is connected to one power source 160, and each power source 160 is connected to (i.e., shared by) two or more processing units 110 (only two are shown). The processing units 110 sharing the same power source 160 may be of the same type or different types.

The example of FIG. 2A shows four power sources 160, each connecting to the processing units 110 of the same type. For example, processing units PU₁ and PU₈, both of which are connected to PS₁, may be two identical processing units. The example of FIG. 2B shows four power sources 160, each connecting to two processing units 110 of different types. For example, processing units PU₄ and PU₅, both of which are connected to PS₄, may have different processing capabilities and/or power efficiency. In alternative embodiments, some power sources 160 may be connected to the same type of processing units 110, and some power sources 160 may be connected to different types of processing units 110. It is understood that the system 100 may include any number of power sources 160 greater than one, and each power source 160 can be connected to any number of processing units 110. In some embodiments, each power source 160 in the system 100 may be connected to the same number of processing units 110. In some embodiments, the power sources 160 in the system 100 may be connected to different numbers of processing units 110.

In a heterogeneous processor system where there are two or more types of processing units, a power manager may determine which type of processing unit to activate based on system performance requirements, workload, power consumption, availability, among other factors. In FIG. 2B, one of P₁-P₄ may be activated when a task arrives with a low performance requirement (e.g., when the required response time is less than a threshold); one of P₅-P₈ may be activated when another task arrives with a high performance requirement (e.g., when the required response time is greater than a threshold).

In an embodiment, when a condition for activating a processing unit is detected, the power manager 121 selects a power source 160 that is connected to inactive processing units only; that is, a power source 160 that is not currently supporting any other active processing units 110. The power manager 121 then activates one of the processing units 110 that are connected to the selected power source 160. The power manager 121 may repeat the selection and activation for M times, until each power source 160 in the system 100 has one activated processing unit 110.

In one embodiment, the condition for activating or deactivating a processing unit 110 may include, but are not limited to, changed workload or performance requirements. However, other predetermined condition may also exist. In one embodiment, the power manager 121 coordinates its operations with a task scheduler that is responsible for task scheduling when a new task arrives. After the power manager 121 turns on one of the processing units 110, the task scheduler may schedule the new task to that processing unit.

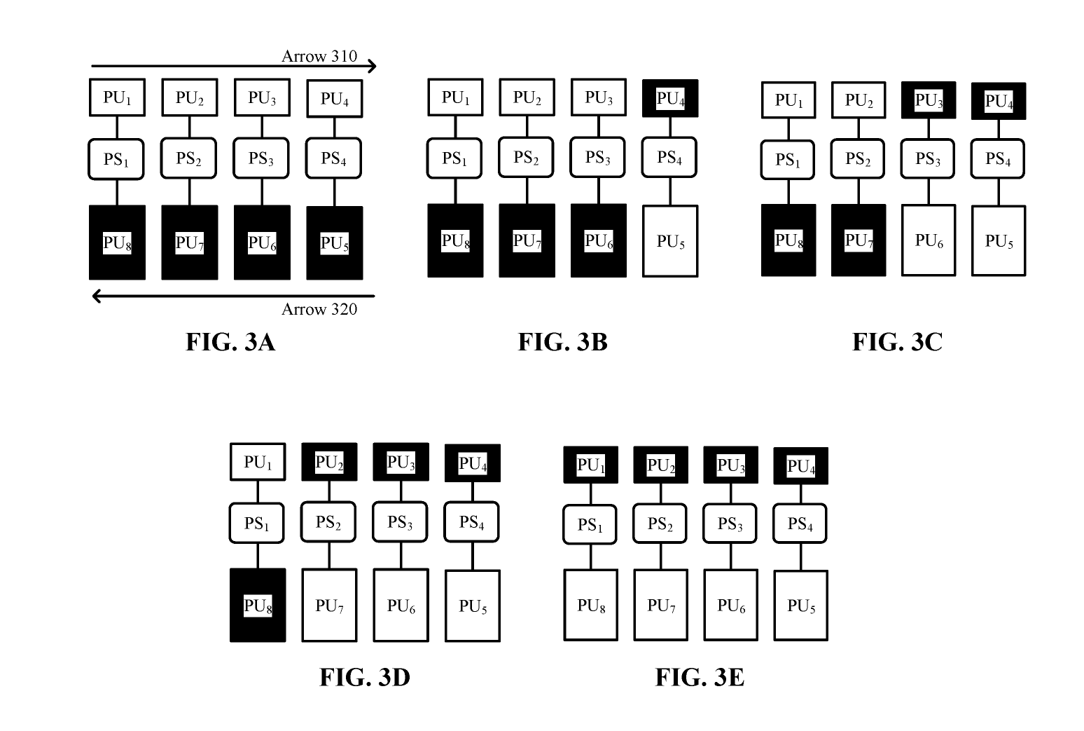

FIGS. 3A-3E illustrate a sequence of operations for activating and deactivating processing units according to one embodiment. In this embodiment, each power source (denoted as “PS”) is connected to a processing unit of a first type (denoted as “PU” in the row above the power sources) and a processing unit of a second type (denoted as “PU” in the row below the power source); that is, the number of processing units N is twice the number of power sources M. The processing units may be activated following a predetermined order. For example, the processing units of a first type (e.g., PU₁-PU₄) may be activated in a first order, as indicated by an arrow 310, and the processing units of a second type (e.g., PU₅-PU₈) may be activated in a second order, as indicated by an arrow 320, where the second order is reverse to the first order.

When a condition for deactivating a processing unit is detected, the processing units of the first type may be deactivated in the second order. If the processing units of the first type has been activated in the first order, the deactivation may start from the processing unit (of the first type) that was most recently activated. The processing units of the second type may be deactivated in the first order. If the processing units of the second type has been activated in the second order, the deactivation may start from the processing unit (of the second type) that was most recently activated.

In FIG. 3A, all of the processing units of the first type (PU₁-PU₄) are activated, and all of the processing units of the second type (PU₅-PU₈) are deactivated, shown as black blocks. When workload or performance requirement changes, a power manager (such as the power manager 121 of FIG. 1) may determine to switch the activated processors from PU₁-PU₄ to PU₅-PU₈, which entails deactivating PU₁-PU₄ and activating PU₅-PU₈. FIG. 3B-3E illustrate, step by step, the order in which PU₁-PU₄ are deactivated and PU₅-PU₈ are activated. In FIG. 3B, PU₄ is deactivated and PU₅ is activated. In FIG. 3C, PU₃ is deactivated and PU₆ is activated. In FIG. 3D, PU₂ is deactivated and PU₇ is activated. In FIG. 3E, PU₁ is deactivated and PU₈ is activated; as a result, all of the processing units of the second type (PU₅-PU₈) are activated, and all of the processing units of the first type (PU₁-PU₄) are deactivated at the end of the operation sequence.

The sequence of operations in FIGS. 3A-3E illustrate that the order of activating PU₅-PU₈ is the same as the order of deactivating PU₁-PU₄, in accordance with the arrow 320 of FIG. 3A. In this embodiment, every time a given processing unit of a second type is activated, the processing unit of the first type that is connected to the same power source as the given processing unit is deactivated. As such, the power source supplies power to only one activated processing unit.

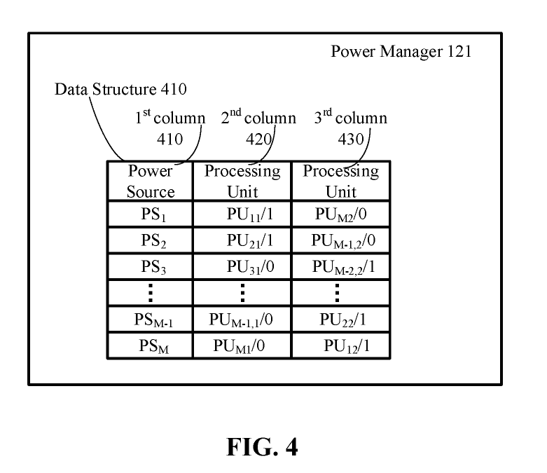

FIG. 4 illustrates the information tracked by a power manager (such as the power manager 121 of FIG. 1) according to one embodiment, for activating and deactivating the processing units following predetermined orders such as the arrow 310 and arrow 320 shown in FIG. 3A. The power manager 121 may maintain a data structure 410 in which the power sources are ordered in a sequence (shown in a first column 410). Processing units of the first type are shown in a second column 420, and processing units of the second type are shown in a third column 430. Each power source is connected to the two processing units in the same row. The data structure 410 also includes an activation/deactivation state of each processing unit; in this example, activation is indicated by “/1” and deactivation is indicated by “/0”. In alternative embodiments, the activation/deactivation state of each processing unit may be stored in a different data structure, and may be indicated by a different indicator from what is shown in FIG. 4. It is understood that the columns and rows are used as an example, in alternative embodiments, the information of the power sources and processing units may be organized differently from what is shown in FIG. 4.

Furthermore, in this example, each processing unit is given an index consisting of two numbers. The first number indicates the processing unit's sequential order of activation. The order of deactivation is opposite to the order of activation. The second number is used to differentiate different types of the processing units. In alternative embodiments, the data structure 410 may include different indicators for conveying the information with respect to the order of activation and processor types.

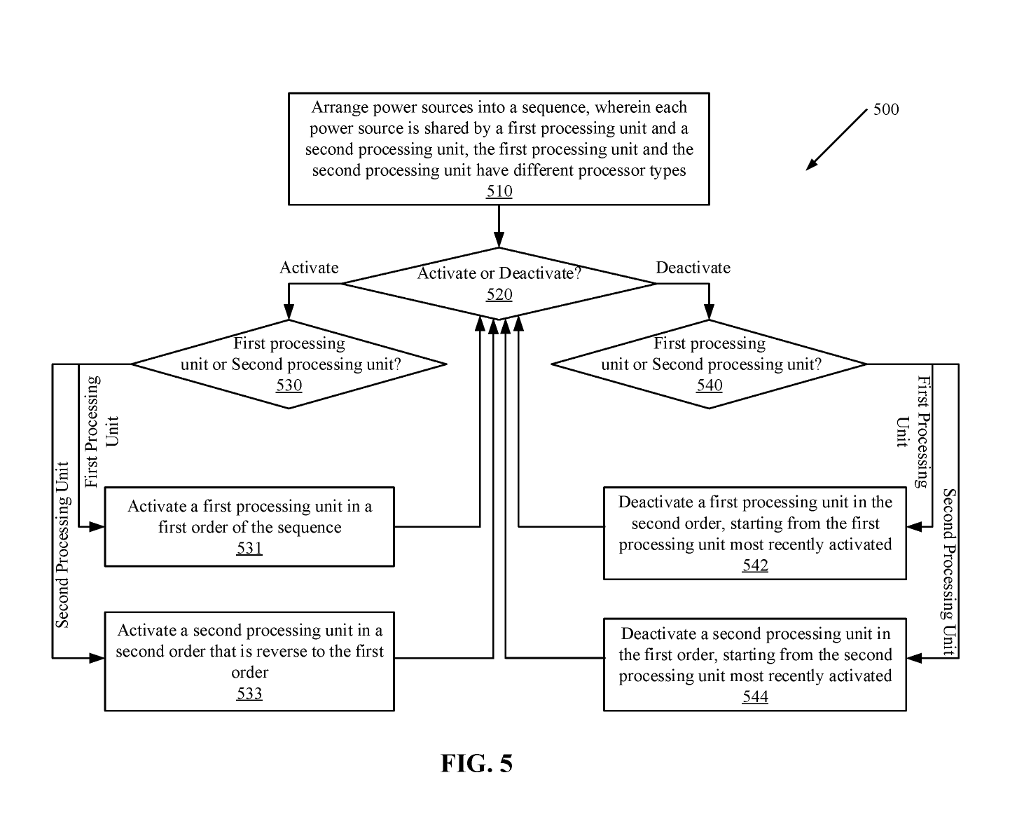

FIG. 5 is a flow diagram illustrating a method 500 for managing activation and deactivation of processing units in a system according to one embodiment. The system includes multiple power sources and multiple processing units, where the processing units further include a set of first processing units and a set of second processing units. The first processing units and the second processing units have different processor types. Each power source is shared by a first processing unit and a second processing unit. A non-limiting example arrangement of the processing units is shown in FIG. 2B. In one embodiment, the method 500 may be performed by the system 100; more specifically, by the power manager 121 of FIG. 1.

The method 500 begins with arranging the power sources in a sequence (step 510). In response to a detected condition, the power manager 121 determines whether to activate or deactivate a processing unit (step 520). If the power manager 121 determines to activate, it further determines whether to activate a first processing unit or a second processing unit (step 530). Similarly, if the power manager 121 determines to deactivate, it further determines whether to deactivate a first processing unit or a second processing unit (step 540). The determination of whether to activate/deactivate a first processing unit or a second processing unit may be based on, for example, performance requirements, workload, availability, power consumption, among other factors.

If the power manager 121 determines to activate a first processing unit, one of the first processing units is activated in a first order of the sequence (step 531). The first order may be the same order as how the power sources are ordered, or may be another predetermined order. If the power manager 121 determines to activate a second processing unit, one of the second processing units is activated in a second order (step 533). The second order is reverse to the first order. A non-limiting example of the first order and the second order is shown in FIG. 3A as arrow 310 and arrow 320, respectively.

If the power manager 121 determines to deactivate a first processing unit, one of the first processing units is deactivated in the second order (step 542). If the order of activation is followed in step 531, the deactivated first processing unit is the first processing unit that was most recently activated. If the power manager 121 determines to deactivate a second processing unit, one of the second processing units is deactivated in a first order (step 544). If the order of activation is followed in step 533, the deactivated second processing unit is the second processing unit that was most recently activated. After a processing unit is activated or deactivated, the method 500 may repeat from step 520 at which the power manager 121 determines whether to activate or deactivate another processing unit when a condition is detected.

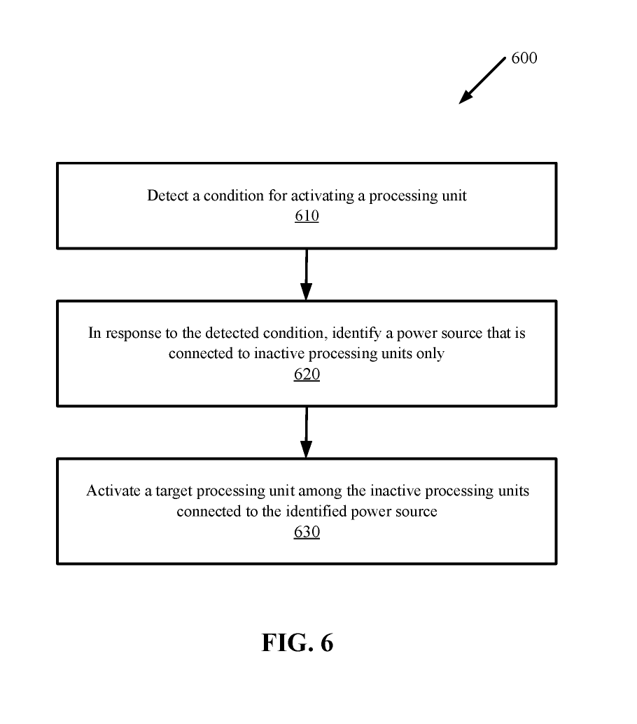

The method 500 may be used to activate and deactivate processing units in a system where each power source is connected to two different types of processing units. When a power source is connected to two or more processing units of the same type or different types, a method as described below in connection with FIG. 6 may be used to manage power consumption.

FIG. 6 is a flow diagram illustrating a method 600 for managing power consumption of a system according to one embodiment. The system includes multiple processing units and multiple power sources, such as the system 100 of FIG. 1, where each power source is connected to two or more processing units. In one embodiment, the method 600 may be performed by the system 100; more specifically, by the power manager 121 of FIG. 1.

The method 600 starts when a condition is detected for activating a processing unit (step 610). In response to the detected condition, the power manager 121 identifies a power source that is connected to inactive processing units only (step 620). The power manager 121 then activates a target processing unit among the inactive processing units connected to the identified power source (step 630). In one embodiment, the method 600 may be performed repeatedly at runtime until all power sources are connected to one activated processing unit.

In one embodiment, the detected condition may be a change in system performance requirements or workload, such that an additional or a different processing unit is needed. Other system conditions may also trigger the activation of a processing unit.

As such, the methods 500 and 600 manage power consumption by improving power efficiency when the number of required processing units is not greater than the number of power sources in a system. Moreover, the method 500 provides a technique for activating and deactivating the processing units efficiently. Therefore, power efficiency of the system can be improved or maximized.

In some scenarios where the performance requirement exceeds a threshold, a multicore processor system may activate more processing units than the number of power sources. These scenarios are performance-driven; that is, the concern for power efficient becomes secondary. The embodiments described herein are applicable to power efficiency-driven scenarios especially where the number of processing units is not greater than the number of power sources.

The operations of the flow diagrams of FIGS. 5 and 6 have been described with reference to the exemplary embodiment of FIG. 1. However, it should be understood that the operations of the flow diagrams of FIGS. 5 and 6 can be performed by embodiment of the disclosure other than the embodiment discussed with reference to FIG. 1, and the embodiment discussed with reference to FIG. 1 can perform operations different than those discussed with reference to the flow diagrams. While the flow diagrams of FIGS. 5 and 6 show a particular order of operations performed by certain embodiments of the disclosure, it should be understood that such order is exemplary (e.g., alternative embodiments may perform the operations in a different order, combine certain operations, overlap certain operations, etc.).

While the disclosure has been described in terms of several embodiments, those skilled in the art will recognize that the disclosure is not limited to the embodiments described, and can be practiced with modification and alteration within the spirit and scope of the appended claims. The description is thus to be regarded as illustrative instead of limiting.

What is claimed is:

1. A method for improving power consumption of a system that includes multiple processing units and multiple power sources, wherein each power source is connected to two or more processing units, the method comprising:
detecting a condition for activating a processing unit;
in response to the detected condition, identifying a power source that is connected to inactive processing units only; and
activating a target processing unit among the inactive processing units connected to the identified power source.

2. The method of claim 1, wherein a total number of required processing units is not greater than a total number of the power sources in the system.

3. The method of claim 1, wherein activating the target processor further comprises:
turning on the target processing unit when the target processing unit is in a power-off state or an ultra-low power state.

4. The method of claim 3, wherein activating the target processor further comprises:
scheduling a task to the target processing unit after the target processing unit is turned on.

5. The method of claim 1, wherein the power sources are voltage regulators that supply respective voltages to the processing units.

6. The method of claim 1, wherein each processing unit is a cluster of processors, a processor of multiple cores, or a core.

7. The method of claim 1, wherein the processing units include first processing units of a first type and second processing units of a second type different from the first type, and wherein each power source is shared by one of the first processing units and one of the second processing units, the method further comprises:
arranging the power sources into a sequence;
activating the first processing units in a first order of the sequence; and
activating the second processing units in a second order that is reverse to the first order.

8. The method of claim 7, further comprising:
deactivating the first processing units in the second order; and
deactivating the second processing units in the first order.

9. The method of claim 8, wherein deactivating the first processing units starts from a first processing unit most recently activated, and deactivating the second processing units starts from a second processing unit most recently activated.

10. The method of claim 7, wherein the first processing units and the second processing units have different processing capabilities or different power efficiency.

11. A system operative to improve power consumption, the system comprising:
a plurality of processing units;
a plurality of power sources, wherein each power source is connected to two or more processing units; and
a power manager module coupled to the processing units, wherein the power manager module is further operative to:
detect a condition for activating a processing unit among the plurality of processing units;
in response to the detected condition, identify a power source that is connected to inactive processing units only; and
activate a target processing unit among the inactive processing units connected to the identified power source.

12. The system of claim 11, wherein a total number of required processing units is not greater than a total number of the power sources in the system.

13. The system of claim 11, wherein the power manager module is further operative to turn on the target processing unit to activate the processing unit when the target processing unit is in a power-off state or an ultra-low power state.

14. The system of claim 13, wherein the power manager module is further operative to cause a task to be scheduled to the target processing unit after the target processing unit is turned on.

15. The system of claim 11, wherein the power sources are voltage regulators that supply respective voltages to the processing units.

16. The system of claim 11, wherein each processing unit is a cluster of processors, a processor of multiple cores, or a core.

17. The system of claim 11, wherein the processing units include first processing units of a first type and second processing units of a second type different from the first type, and wherein each power source is shared by one of the first processing units and one of the second processing units, the power manager is further operative to:
arrange the power sources into a sequence;
activate the first processing units in a first order of the sequence; and
activate the second processing units in a second order that is reverse to the first order.

18. The system of claim 17, wherein the power manager is further operative to:
deactivate the first processing units in the second order; and
deactivate the second processing units in the first order.

19. The system of claim 18, wherein the power manager is further operative to:
deactivate the first processing units starting from a first processing unit most recently activated; and
deactivate the second processing units starting from a second processing unit most recently activated.

20. The system of claim 17, wherein the first processing units and the second processing units have different processing capabilities or different power efficiency.
